(19) United States
(12) Patent Application Publication
(10) Pub. No.: US 2012/0042274 A1
(43) Pub. Date: Feb. 16, 2012

(54) Method and System for Evaluating Live or Prerecorded Activities

(76) Inventors: Richard Guyon, Mountain View, CA (US); Zaydoon Jawadi, Los Altos Hills, CA (US)

(21) Appl. No.: 13/198,001

(22) Filed: Aug. 4, 2011

Related U.S. Application Data
(63) Continuation of application No. 61/373,200, filed on Aug. 12, 2010.

(51) Int. Cl. G06F 3/048

(52) U.S. Cl. 715/780

(57) ABSTRACT

Method of and system for evaluating and annotating live or prerecorded activities, such as live or prerecorded public speaking. Evaluations and annotations may be generated in real-time while the activity is taking place or afterwards without the need for a video or audio recording, or may be generated while recording or watching a recording. The technique comprises a hierarchical multi-level menu of canned and/or custom comments, canned and/or custom detailed descriptions of comments, custom notes, supplemental informational content, and community-contributed content. The technique also comprises selecting, in response to user input, canned and/or custom comments from the menu, generating timestamped, color-coded annotations corresponding to the comments, and storing the annotations in a database without modifying the prerecorded activity file if any was played while evaluating. Annotations are displayed in real-time during the evaluation and can also be displayed during playback at a later time. An evaluation report may be generated from annotations of an activity, whereby the evaluation report can be organized in chronological order of annotations or by comment category. Evaluations and annotations of live speeches are saved and may later be synchronized with recordings of the speeches. Statistical and trend analysis may be performed comparing a particular evaluation with other evaluations by the same evaluator or by other evaluators.

### CROSS-REFERENCE TO RELATED APPLICATIONS

This application claims the benefit of provisional patent application Ser. No. 61/373,200, file 2010 Aug. 12 by the present inventors.

### BACKGROUND

### Prior Art

The following is a tabulation of some prior art that presently appears relevant:

U.S. Patents

| Pat. No. | Kind Code | Issue Date | Patentee |
|---|---|---|---|
| 2,430,205 | B1 | Nov. 4, 1947 | Barry |
| 3,378,639 | B2 | Apr. 16, 1968 | Dufendach, et al. |
| 5,600,775 | B1 | Feb. 4, 1997 | King & Nelis |
| 5,765,134 | B1 | Jun. 9, 1998 | Kehoe |
| 5,879,246 | B2 | Mar. 9, 1999 | Gebhardt, et. al. |
| 6,326,883 | B1 | Dec. 4, 2001 | Whitehead & Minderler |
| 6,654,588 | B2 | Nov. 25, 2003 | Moskowitz, et. al. |
| 6,963,841 | B2 | Nov. 8, 2005 | Handal, et. al. |
| 7,050,978 | B2 | May 23, 2006 | Silverstein & Zhang |
| 7,058,891 | B2 | Jun. 6, 2006 | O'Neal, et. al. |

U.S. Patent Application Publications

| Publication Number | Kind Code | Publication Date | Applicant |
|---|---|---|---|
| US 2005/0119894 | A1 | Oct. 19, 2004 | Cutler and Gregory |
| US 2007/0100626 | A1 | Nov. 2, 2005 | Miller and Sand |
| US 2007/0160972 | A1 | Jan. 11, 2006 | Clark |
| US 2007/0260461 | A1 | Mar. 7, 2005 | Marple, et. al. |
| US 2009/0089062 | A1 | Apr. 2, 2009 | Fang |

### NON-PATENT LITERATURE DOCUMENTS

Carr, B., Video Annotation and Review System with Adobe Flex, Flash Video and AIR, Miami University, Feb. 15, 2009
Cengage, Speech Studio Instructor User Guide, downloaded Feb. 9, 2010
Cengage, Speech Studio Student User Guide, downloaded Feb. 9, 2010
Farmer, L., MediaNotes Uses in Skills Courses, Instructor's Manual, 2008
Graham, J. and Hull, J., Video Paper: A Paper-Based Interface for Skimming and Watching Video, International Conference on Consumer Electronics, Los Angeles, Jun. 16-18, 2002
Isoprime Corporation, CommuniCoach® Web Version, User Guide—Version 7, 2009
Kipp, M., Anvil 4.0 Annotation of Video and Spoken Language, User Manual, Apr. 9, 2003
Pea, R., et. al., The DIVER Project: Interactive Digital Video Repurposing, IEEE Multimedia, January-March 2004
Pearson, MySpeechLab Website, www.myspeechlab.com, April 2010
Pennsylvania State University, Studiocode White Paper, 2006
Rich, P. and Tripp, T., Video Analysis Tools: Choosing The Right Tool For The Job, Proceedings of Society for Information Technology & Teacher Education International Conference, 2010
Stevens, R. and Macklin, S., Representing, exchanging, and assessing ideas in an almost natural way: The Traces digital media annotation systems, ED-MEDIA World Conference on Educational Multimedia, Hypermedia & Telecommunications, Honolulu, Hi., Jun. 23-28, 2003

As defined by the Merriam-Webster dictionary, to “evaluate” is “to determine or fix the value of” or “to determine the significance, worth, or condition of usually by careful appraisal and study.” An evaluation may include positive feedback, constructive feedback, positive remarks, constructive remarks, appraisal, critique, analysis, suggestions, observations, grading, and instructive information. An evaluator is any person or persons providing evaluation, such as an instructor, teacher, trainer, coach, observer, colleague, inspector, or expert. The evaluator may also be a machine, a robot, or other device(s). An evaluatee (also known as evaluand) is any person or persons performing the activity that the evaluation pertains to, such as a student or a trainee. The evaluatee may also be a machine, a robot, or other device(s).

As defined by the Merriam-Webster dictionary, to “annotate” is “to make or furnish critical or explanatory notes or comment.” Annotation is making or furnishing critical or explanatory note(s) or comment(s). An evaluation often involves making annotations.

A “viewer” refers to any person viewing or watching an evaluation of an activity. The viewer may be the evaluator of the activity, the evaluatee of the activity, an observer of the activity, or any other interested person(s). For example, the evaluation can be viewed by the person who performed the activity at a later time to improve his or her skills.

A “user” refers to an evaluator or a viewer.

As defined by the Merriam-Webster dictionary, “public speaking” is “the act or process of making speeches in public,” or “the art of effective oral communication with an audience.” In public speaking context, the term “speech” refers to a public discourse, an address, or simply a talk. The speaker is the person giving the speech. The speech may be given to an audience in any of multiple scenarios, including to audiences that may be physically present and watching or listening to the speech live; to audiences that may be remotely watching or listening to the speech in a live broadcast on television, on the Internet, on a computer, or through any other medium or device, at the same time while the speech is given; and/or to audiences that may be watching or listening to a video or audio pre-recording of the speech on television, on the Internet, on a computer, on a DVD, or on any medium or device, at a later time than when the speech is given. The term “prerecorded speech,” or “pre-recording,” refers to a video recording or an audio recording of a speech that was previously given, prior to the evaluation. The term “presentation” refers to a speech with slide(s); a presentation is a type of speech; delivering a presentation is a form of public speaking.

In the field of public speaking, an evaluation may be a printed form, an electronic form, a grading rubric, a narrative critique, or a formatted report. The purpose is to provide feedback for improvement to the speaker.

In the field of public speaking, an “evaluator” may be an instructor, a teacher, a trainer, a coach, a speech observer, another speaker, a public speaking student, an audience member, or an expert. An evaluator may be in attendance watching or listening to the speech; an evaluator may be watching or listening to the speech in a live broadcast on television, on the Internet, on a computer, on a DVD, or through any another medium or device; or an evaluator may be watching or listening to a video or audio pre-recording of the speech on television, on the Internet, or on any medium or device.

In the field of public speaking, a “viewer” refers to any person viewing an evaluation of a speech or other activity. The viewer may be the speaker whose speech the evaluation pertains to, may be a member of the audience of the speech, may be a public speaking student, or may be any other interested person. For example, the evaluation can be viewed by the speaker at a later time to improve the speaker's public speaking skills.

The present method and system address the need of evaluators to evaluate and annotate activities, such as public speaking, communication interactions, sports, music, acting, television broadcast, medical services, customer service encounters, and animal training. Evaluations and annotations may be generated while watching or listening to the activities being evaluated and annotated. One embodiment of the present method and system addresses the need of public speaking evaluators to evaluate and annotate live speeches, broadcast speeches, or prerecorded speeches, while watching or listening to these speeches or at a later time.

### BACKGROUND

### Discussion of Prior Art

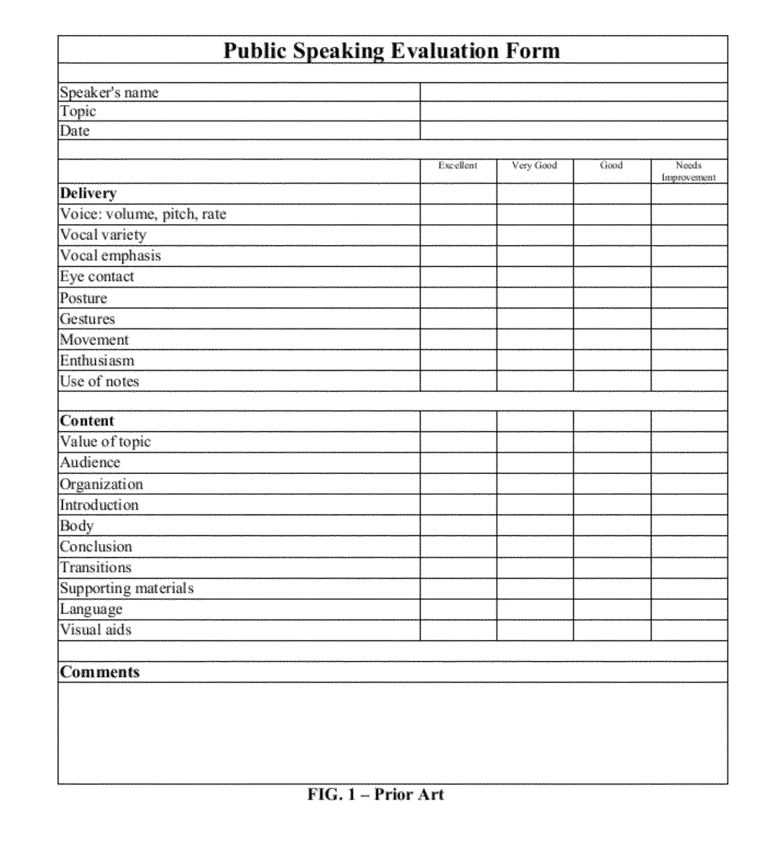

One aspect of the present method and system is evaluating and annotating live activities. One embodiment of this aspect of the present method and system is evaluating and annotating live speeches. Previously, evaluations of live activities were made with static solutions, such as evaluation forms and rubrics, but these had and still have significant problems. The previous solutions did not provide annotation capabilities of live speeches. Thousands of such evaluation forms are available in various formats. A common format is a table or rows and columns, often with evaluation criteria as rows and performance rankings as columns. FIG. 1 is a representative prior-art speech evaluation form. Evaluation criteria may include such elements as voice volume, pitch, rate, and variation; eye contact; posture; content organization; clarity; transitions between main points; and language use. Performance rankings may include performance levels such as excellent, very good, good, fair, and poor (or needs improvement). Most forms include space for comments. Most evaluators use paper copies of the evaluation forms, which the evaluators fill either while listening to the speech or immediately after. Some evaluators use electronic evaluation forms using a word processor, a spreadsheet, or document exchange software, such as Microsoft Word™, Microsoft Excel™, or Adobe Acrobat PDF™. Public speaking evaluation forms have several disadvantages, such as:
They are disruptive to the evaluation process itself; while the evaluator is writing notes or filling an evaluation form, the evaluator is not effectively watching or listening to the speech.
They are static and cannot be modified quickly for each specific evaluation.
They are limited in the number of fields (evaluation criteria and performance rankings) that can be used within the available space in the evaluation form.
They do not provide enough details about the evaluation criteria for the speaker to learn and improve.
They provide feedback that does not include correlation between evaluation criteria and specific locations within the speech to which the evaluation criteria relate.
They are tedious and time consuming to fill; this is especially true for comments that do not fit within the standard criteria in the evaluation forms.
They provide feedback of limited value to evaluatees and recipients of the evaluation forms.
They are prone to evaluator errors, such as spelling mistakes.
They are specific-purpose based on the type of speeches being evaluated; for example, there are informative speech evaluation forms, persuasive speech evaluation forms, and impromptu speech evaluation forms.

Another aspect of the present method and system is evaluating and annotating prerecorded activities. One embodiment of this aspect of the present method and system is evaluating and annotating prerecorded speeches. Various previous solutions to the need of evaluating and annotating prerecorded activities and speeches exist.

The first group of previous solutions to the need of evaluating and annotating prerecorded activities and speeches is using public evaluation forms and rubrics. Using evaluation forms and rubrics for evaluating and annotating prerecorded activities and speeches suffers from the same disadvantages as using evaluation forms and rubrics for evaluating and annotating live activities and speeches.

The second group of previous solutions to the need of evaluating and annotating prerecorded activities and speeches is using annotation solutions, such as described in U.S. Pat. No. 5,600,775, or by using video management and annotation software, such as Anvil, DIVER/WebDiver, Mediallotes, Prezi Video Annotation and Review System, Traces, Transana, Video Analysis Support Tool (VAST), Video Analysis Tool (VAT), Video Annotation and Review System (Miami University), Video Interactions for Teaching and Learning (VITAL), Video Paper, VideoAnt, Viddler, VoiceThread, and the YouTube annotation capability. Such annotation software may provide time synchronization between the annotations and the video, but suffers from similar disadvantages as those of the evaluation forms and rubrics. Such annotation software also does not have specific provisions or evaluation criteria for the specific activity, such as public speaking; this limitation makes the software difficult to use or renders it unusable for activity or public speaking evaluation. In addition, most of the annotation software supports only video recordings but not audio recordings and not live activities or speeches.

The third group of previous solutions to the need of evaluating and annotating prerecorded speeches is using public speaking course textbook supplemental software, such as MySpeechLab, SpeechStudio, and SpeechMate. Such textbook supplemental software may provide time synchronization between the annotations and the video, and may include specific provisions for public speaking evaluation criteria. However, the textbook supplemental software suffers from significant limitations. For example, the textbook supplemental software does not provide a fast way to generate annotations automatically with a single click, and does not provide a way to insert detailed comments automatically in the evaluation. In addition, the textbook supplemental software supports only video recordings but not audio recordings and not live activities or speeches that are not being recorded.

The fourth group of previous solutions to the need of evaluating and annotating prerecorded activities and speeches is using activity video annotation software, such as Communicoach and Studiocode. Such activity video annotation software may provide time synchronization between the annotations and the video, and may include specific provisions for activity or public speaking evaluation criteria. However, these activity video annotation software solutions suffer from significant limitations. For example, Studiocode is an integrated video capture, coding, annotation, and distribution system; as such, Studiocode is complex to setup, learn, and use; furthermore, Studiocode does not integrate easily with YouTube, and Studiocode does not provide a convenient way to have detailed comments inserted automatically in the evaluation. In addition, Studiocode supports only video recordings but not audio recordings or live activities or speeches that are not being recorded.

The previous solutions to the need of evaluating and annotating prerecorded activities and speeches do not allow evaluating and annotating live speeches.

Thus, the prior art is awkward, complex, limited, difficult to use, difficult to customize, and less versatile.

### ADVANTAGES

Unlike evaluation forms and rubrics, the present method and system use software for evaluating and annotating live activities, including public speeches, in real-time. The technique comprises a menu of evaluation comments; comments are herein referred to as comments. The comment menu may be a hierarchical multi-level menu of canned and/or custom comments, canned and/or custom detailed descriptions of comments, custom notes, supplemental informational content, and community-contributed content. The technique also comprises selecting in response to single-action user input a canned comment and/or a custom comment from the menu, generating a timestamped annotation corresponding to the comment, and storing the annotation in a database without modifying the prerecorded activity file if one is played while evaluating. Annotations are displayed in real-time during the evaluation and can also be displayed during playback at a later time. Annotations from several evaluators may be merged and viewed simultaneously. An evaluation report may be generated from annotations of an activity, whereby the evaluation report can be organized in chronological order of annotations or by comment category. The present method and system result in several advantages, such as:
They are less disruptive to the evaluation process itself; annotating the activity (or speech) is faster, allowing the evaluator to quickly resume watching or listening to the activity (or speech).
They provide dynamic evaluation that can be modified easily and quickly for each different evaluation; for example, annotations with custom comments can be added for different evaluation criteria.
They provide a large number of canned and custom evaluation criteria that otherwise would not be possible to fit in prior-art evaluation forms.
They provide more details about the evaluation criteria for the person performing the activity (or the speaker) to learn and improve.
They provide feedback that can be grouped categorically or chronologically. The chronological (time-based) evaluation reporting provides a correlation between the evaluation criteria and the specific locations within the activity (or speech) that the evaluation criteria refer to.
They are easy and quick to generate.
They provide more helpful feedback to evaluatees and recipients of the evaluations.
They are less prone to evaluator errors, because most of the evaluation text is generated automatically.
They are general-purpose and can be used with a variety of activities (or speech types), such as informative speeches, persuasive speeches, and impromptu speeches.
They display annotations dynamically, making the annotations easier to understand and correlate to the activity (or speech).
They store annotations of live speeches with timestamps relating the annotations to the activity (or speech).
They can synchronize annotations with a video or audio recording of the activity (or speech) at a later time.
They provide statistical and trend analysis of the evaluator's own evaluation history as well as compared with evaluations of other evaluators.
They allow the evaluator to customize the menus more easily.
They offer more flexible, easier to use, and easier to define keyboard shortcuts.

Although there are other activity and public speaking evaluation and annotation solutions, various aspects of the present method and system are superior because:
They are more efficient.
They are faster to use during the evaluation.
They reduce evaluation time.
They reduce the time to generate evaluation reports.
They are less complicated.
They are easier to install and run.
They are easier to learn.
They are easier and less awkward to navigate.
They are easier and less awkward to use.
They are easier and less awkward to customize.
They are less expensive.
They are more versatile.
They are easier and less expensive to implement.
They are less prone to evaluator errors.
They display annotations dynamically, making the annotations easier to understand and correlate to the activity (or speech).
They store annotations of live activities (or speeches) with timestamps that relate the annotations to specific locations within the activities (or speeches).
They can synchronize annotations with a video or audio recording of the activity (or speech) at a later time.
They provide statistical and trend analysis of the evaluator's own evaluation history as well as compared with evaluations of other evaluators.
They allow the evaluator to customize the menus more easily.
They offer more flexible, easier to use, and easier to define keyboard shortcuts.
They include video and audio enhanced playback capabilities for easier navigation.

The present method and system satisfy previously unfulfilled needs in the evaluation and annotation of live activities and speeches. For example, attempts over the last several decades have failed to simplify and automate the evaluation of live public speaking and have failed to provide annotation capabilities of live public speaking. The present method and system make it possible to annotate live activities and speeches; the present method and system also make evaluation of live activities and speeches more efficient, as well as easier and faster to learn and use. The evaluation and annotation of the present method and system comprise such novel capabilities as a hierarchical multi-level menu of canned and/or custom comments, canned and/or custom detailed descriptions of comments, custom notes, single-action user selection of canned and/or custom comments from the menu, timestamped annotations, storing annotations in a database, merging simultaneous annotations from several evaluators, automated generation of chronological and/or category-based evaluation reports from annotations, subsequent synchronizing with recordings of the evaluated activities (or speeches), and statistical and trend analysis.

The present method and system satisfy previously unfulfilled needs in the evaluation and annotation of prerecorded activities and speeches. For example, the present method and system make evaluation and annotation of prerecorded activities and speeches more efficient, as well as easier and faster to learn and use. The present method and system comprise such novel capabilities as a hierarchical multi-level menu of canned and/or custom comments, canned and/or custom detailed descriptions of comments, and single-action user selection of canned and/or custom comments from the menu.

Thus several advantages of one or more aspects are to provide faster, clearer, easier, more dynamic, more comprehensive, and more usable evaluations. These and other advantages of one or more aspects will become apparent from a consideration of the ensuing description and accompanying drawings.

### SUMMARY

The present method and system address the need to evaluate live and prerecorded activities, such as public speaking. The present method and system comprise a processing device and the ability to generate annotations. The annotations may be generated using a menu of canned comments, custom comments, or canned and custom comments. An annotation comprises a timestamp, a comment ID, a comment title, a comment impact, a comment description, custom note, supplemental informational content, or community-contributed content. The menu may be a hierarchical multi-level menu, and may be color coded. The menu may be controlled using a mouse, a touch screen, a keyboard shortcut, a voice command, or other instrument. Keyboard shortcuts may comprise sequences corresponding to menu selections. Menus may be customized. Evaluation reports may be generated from annotations. An evaluation of a live activity may be synchronized with a recording of the live activity.

### DRAWINGS

### Figures

FIG. 1 is a perspective prior-art public speaking evaluation form.

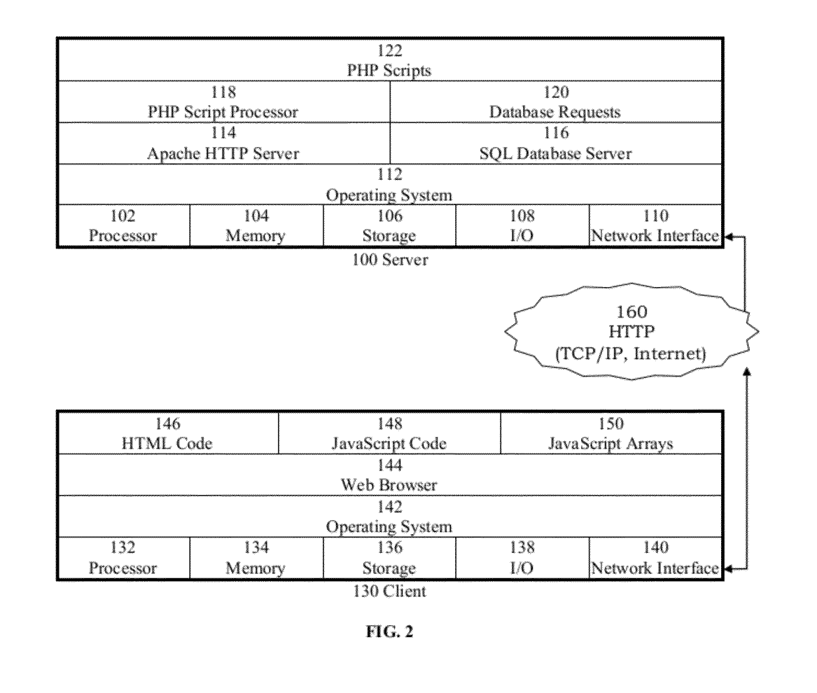

FIG. 2 is a perspective view of one system implementation embodiment.

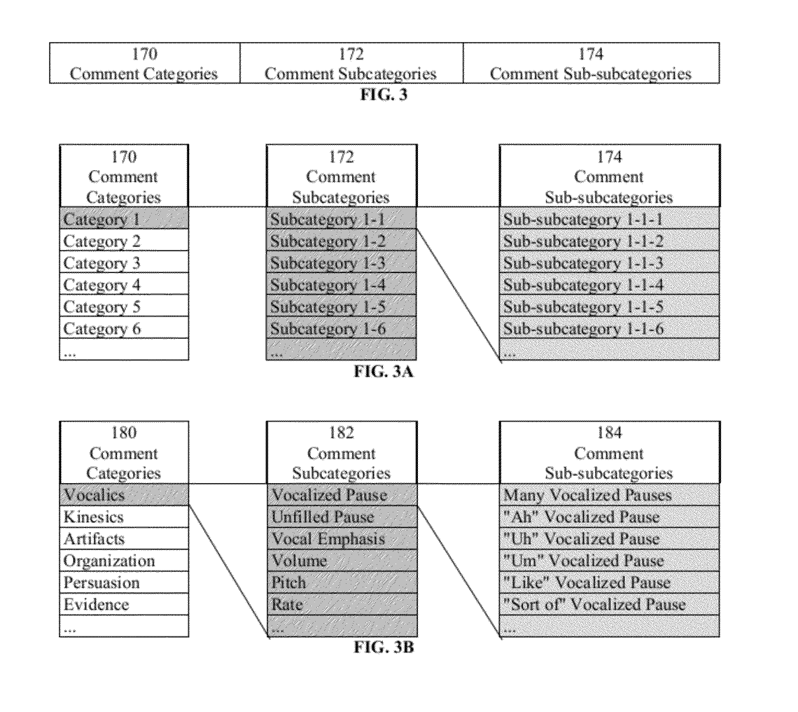

FIG. 3 is a perspective comment hierarchy.

FIG. 3A is a perspective sample comment hierarchy.

FIG. 3B is a perspective sample comment hierarchy with a public speaking activity.

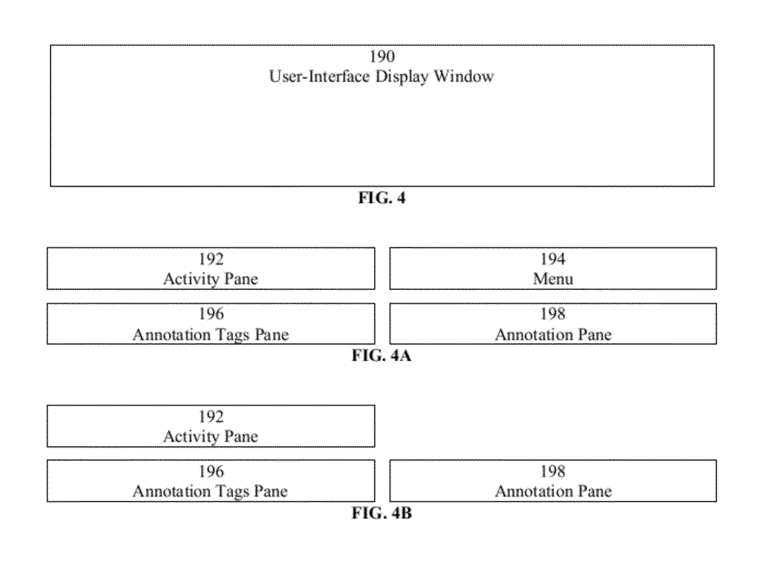

FIG. 4 is a perspective view of a User-Interface Display Window 190.

FIG. 4A shows perspective content of the User-Interface Display Window 190 in evaluation mode.

FIG. 4B shows perspective content of the User-Interface Display window 190 in view mode.

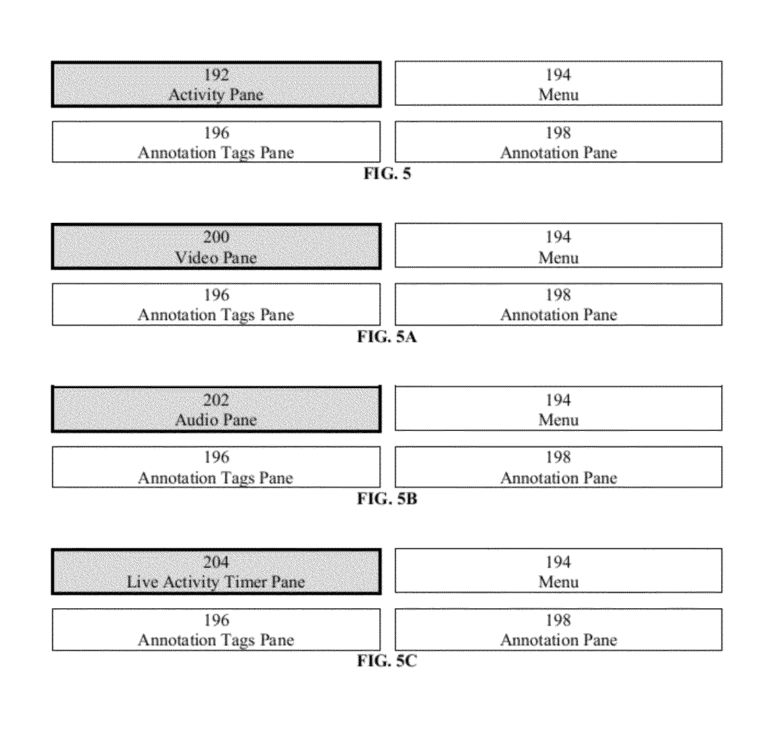

FIG. 5 is a perspective view of the User-Interface Display Window 190 with the Activity Pane 192 highlighted.

FIG. 5A shows perspective content of the Activity Pane 192 when evaluating a prerecorded video file.

FIG. 5B shows perspective content of the Activity Pane 192 when evaluating a prerecorded audio file.

FIG. 5C shows perspective content of the Activity Pane 192 when evaluating a live activity.

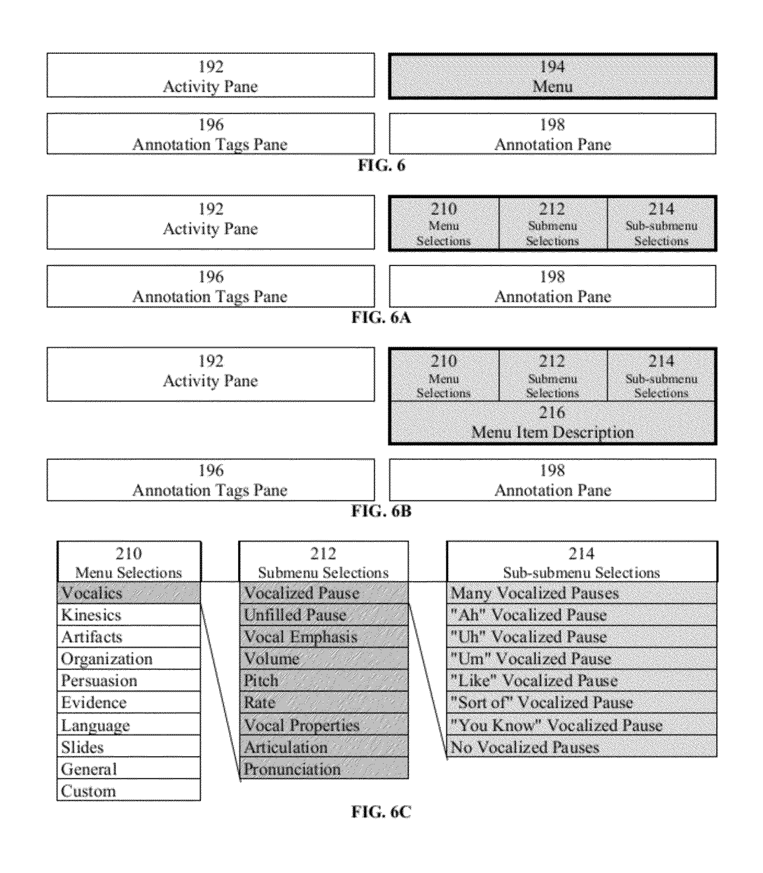

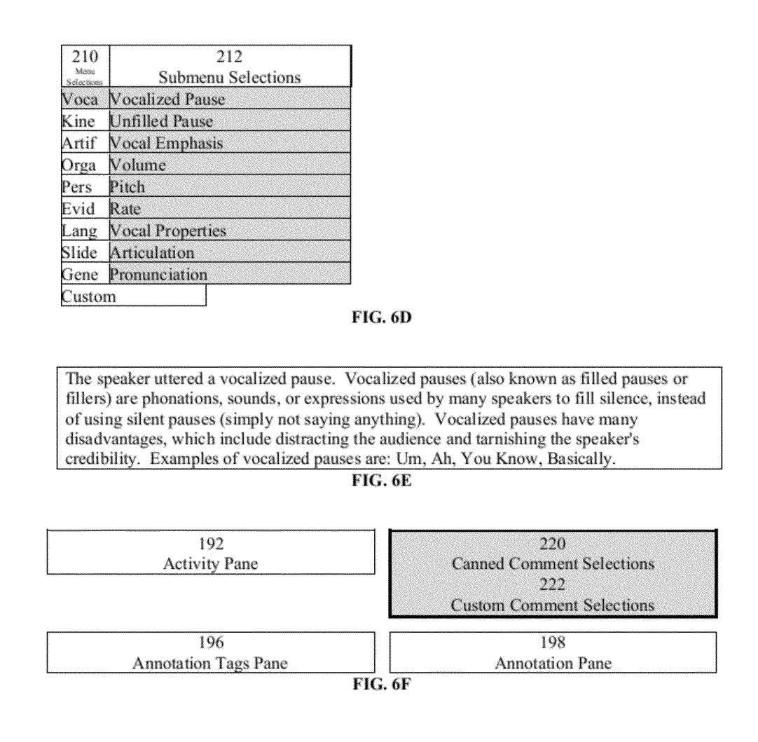

FIG. 6 is a perspective view of the User-Interface Display Window 190 with the Menu 194 highlighted.

FIG. 6A is a perspective view of the User-Interface Display Window 190 with the content of the Menu 194 highlighted, without Menu Item Description 216.

FIG. 6B is a perspective view of the User-Interface Display Window 190 with the content of the Menu 194 and the Menu Item Description 216 highlighted.

FIG. 6C is a perspective view of sample menu selections, submenu selections, and sub-submenu selections of the Menu 194.

FIG. 6D is a perspective view of sample menu selections overlaid with submenu selections.

FIG. 6E is a perspective view of sample Menu Item Description 216 of the Menu 194.

FIG. 6F is a perspective view of the User-Interface Display Window 190 with the content of the Menu 194 highlighted, showing Canned Comment Selections 220 and Custom Comment Selections 222.

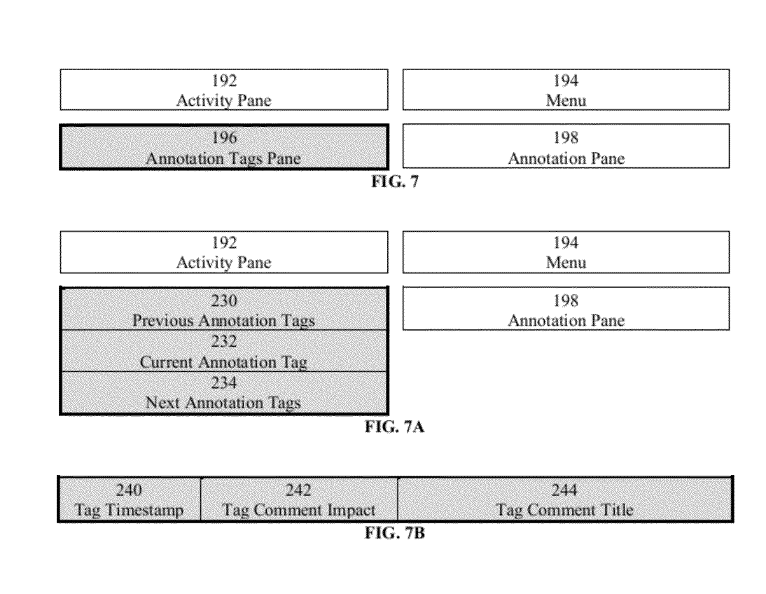

FIG. 7 is a perspective view of the User-Interface Display Window 190 with the Annotation Tags Pane 196 highlighted.

FIG. 7A is a perspective view of the User-Interface Display Window 190 with the content of the Annotation Tags Pane 196 highlighted.

FIG. 7B shows perspective content of one entry in the Annotation Tags Pane 196.

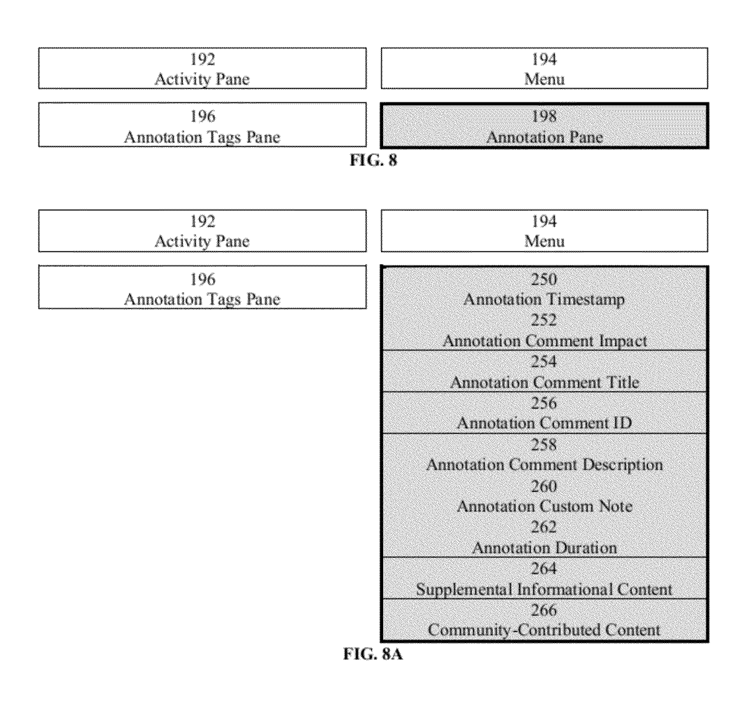

FIG. 8 is a perspective view of the User-Interface Display Window 190 with the Annotation Pane 198 highlighted.

FIG. 8A is a perspective view of the User-Interface Display Window 190 with the content of the Annotation Pane 198 highlighted.

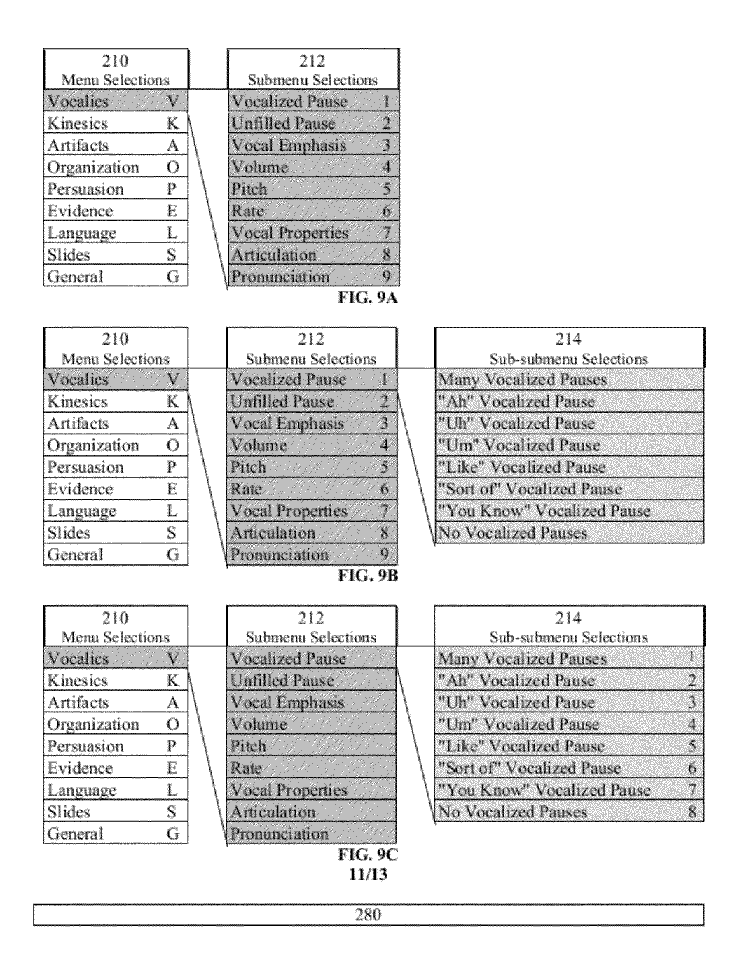

FIG. 9A is perspective view of the Menu 194 display with a double-key keyboard shortcut.

FIG. 9B is perspective view of the Menu 194 display with a triple-key keyboard shortcut while the first digit is still pressed.

FIG. 9C is perspective view of the Menu 194 display with a triple-key keyboard shortcut after the first digit is released.

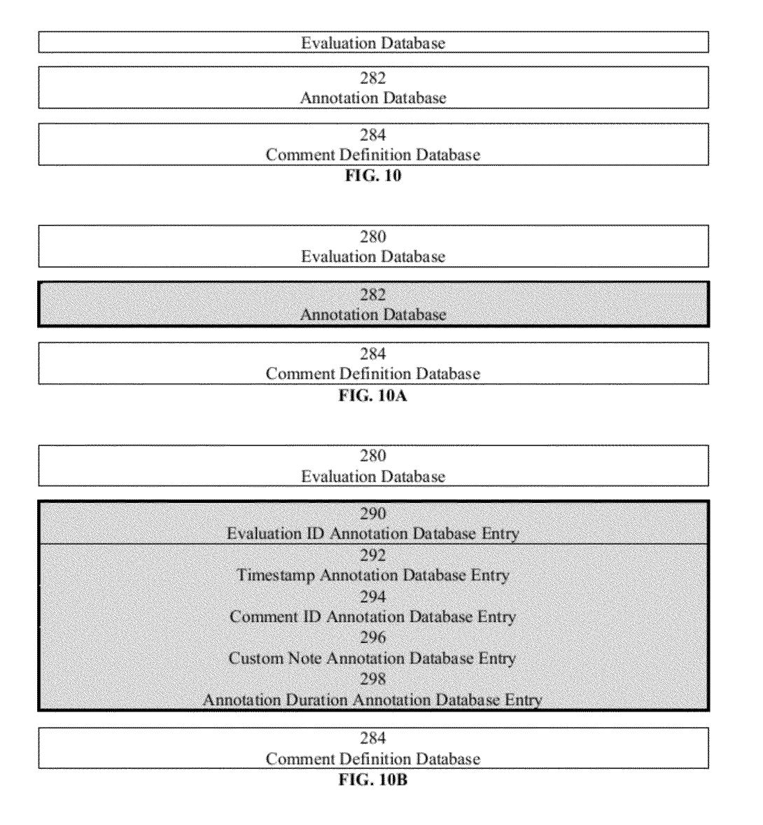

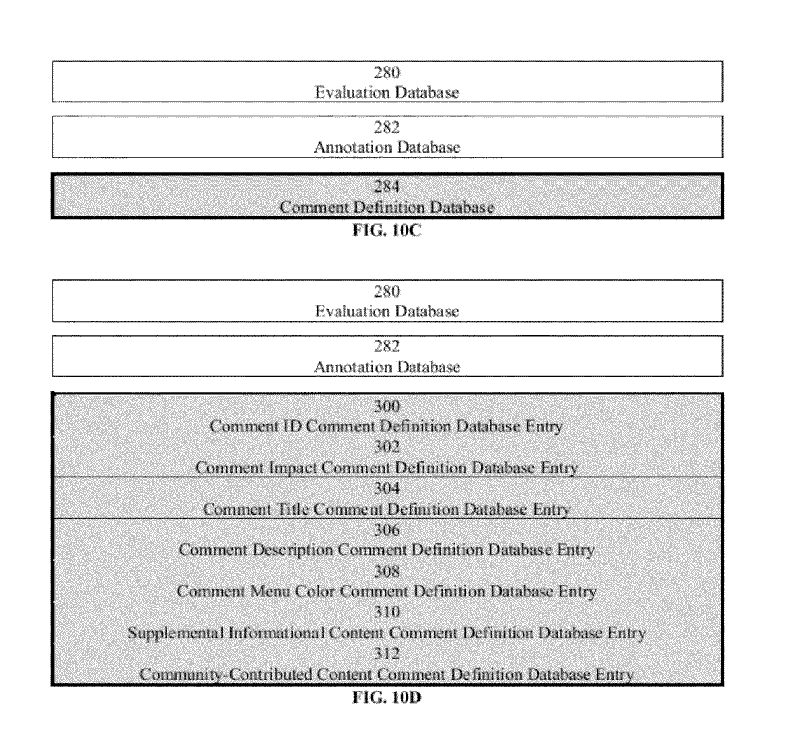

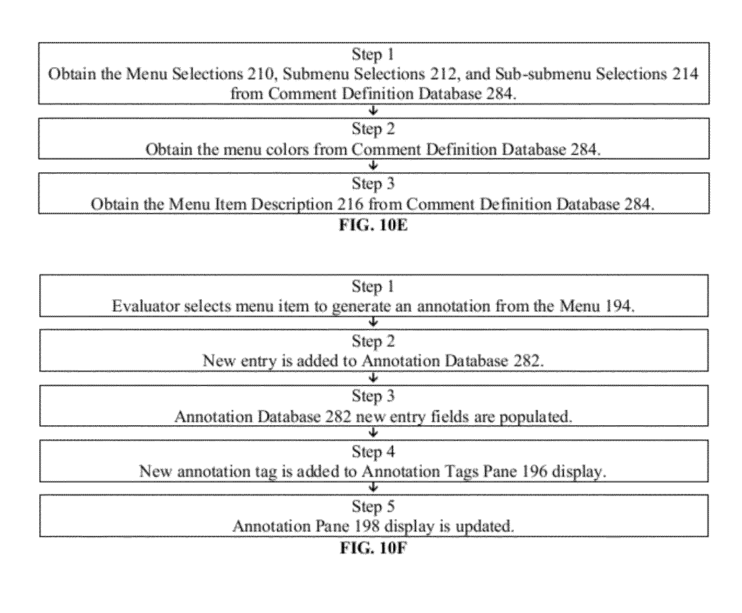

FIG. 10 is a perspective view of three databases used by the present method and system.

FIG. 10A is a perspective view of the databases with the Annotation Database 282 highlighted.

FIG. 10B is a perspective view of the databases with content of an entry in the Annotation Database 282 highlighted.

FIG. 10C is a perspective view of the databases with the Comment Definition Database 284 highlighted.

FIG. 10D is a perspective view of the databases with content of an entry in the Comment Definition Database 284 highlighted.

FIG. 10E is a perspective flowchart for building the Menu 194 display.

FIG. 10F is a perspective flowchart for generating annotations.

### DRAWINGS

### Reference Numerals

100 Server
102 Processor
104 Memory
106 Storage
108 I/O
110 Network Interface
112 Operating System
114 Apache HTTP Server
116 SQL Database
118 PHP Script Processor
120 Database Requests
122 PHP Scripts
130 Client
132 Processor
134 Memory
136 Storage
138 I/O
140 Network Interface
142 Operating System
144 Web Browser
146 HTML Code
148 JavaScript Code
150 JavaScript Arrays
160 HTTP (TCP/IP, Internet)
170 Comment Categories
172 Comment Subcategories
174 Comment Sub-subcategories
180 Comment Categories in Public Speaking Activity
182 Comment Subcategories in Public Speaking Activity
184 Comment Sub-subcategories in Public Speaking Activity
190 User-Interface Display Window
192 Activity Pane
194 Menu
196 Annotation Tags Pane
198 Annotation Pane
200 Video Pane
202 Audio Pane
204 Live Activity Timer Pane
210 Menu Selections
212 Submenu Selections
214 Sub-submenu Selections
216 Menu Item Description
220 Canned Comment Selections
222 Custom Comment Selections
230 Previous Annotation Tags
232 Current Annotation Tag
234 Next Annotation Tags
240 Tag Timestamp
242 Tag Comment Impact
244 Tag Comment Title
250 Annotation Timestamp
252 Annotation Comment Impact
254 Annotation Comment Title
256 Annotation Comment ID
258 Annotation Comment Description
260 Annotation Custom Note
262 Annotation Duration
264 Supplemental Informational Content
266 Annotation Community-Contributed Content
280 Evaluation Database
282 Annotation Database
284 Comment Definition Database
290 Evaluation ID Annotation Database Entry
292 Timestamp Annotation Database Entry
294 Comment ID Annotation Database Entry
296 Custom Note Annotation Database Entry
298 Annotation Duration Annotation Database Entry
300 Comment ID Comment Definition Database Entry
302 Comment Impact Comment Definition Database Entry
304 Comment Title Comment Definition Database Entry
306 Comment Description Comment Definition Database Entry
308 Comment Menu Color Comment Definition Database Entry
310 Supplemental Informational Content Comment Definition Database Entry
312 Community-Contributed Content Comment Definition Database Entry

### DETAILED DESCRIPTION

### Detailed Description

### FIG. 2—First Embodiment

The present method and system comprise a processing device.

FIG. 2 illustrates one embodiment of a processing device using web-based, client-server implementation comprising a Server 100 and a Client 130, connected using HTTP (TCP/IP, Internet) 160.

The Server 100 is a computer system comprising hardware and software. The server hardware comprises (a) a Processor 102, for example an Intel 2.3 GHz Pentium, (b) Memory 104, for example 8 GB of random access memory, (c) Storage 106, for example a 500 GB hard disk, (d) I/O 108, Input/Output devices, such as monitor, keyboard, and mouse, and (e) Network Interface 110, connecting the computer to the Internet, to a router that connects to the Internet, or to a network the connects to the Internet.

The server software comprises (a) an Operating System 112, such as Linux, which manages the system resources, (b) an Apache HTTP Server 114, which manages HTTP/Internet interactions, (c) an SQL Database Server 116, such as MySQL, and (d) a PHP Script Processor 118. The PHP Script Processor 118 processes PHP Scripts 122. Based on the PHP Scripts 122, the PHP Script Processor 118 may generate Database Requests 120 and send them to the SQL Database Server 116 to process. The PHP Scripts 122 contain the specific processes and functions of the present method and system. The other server software components are mostly what is collectively referred to as a LAMP environment (Linux, Apache, MySQL, PHP).

The Client 130 is a computer system comprising hardware and software. The client hardware comprises (a) a Processor 132, for example an Intel 2.3 GHz Pentium, (b) Memory 134, for example 8 GB of random access memory, (c) Storage 136, for example a 500 GB hard disk, (d) I/O 138, Input/Output devices, such as monitor, keyboard, and mouse, and (e) Network Interface 140, connecting the computer to the Internet, to a router that connects to the Internet, or to a network the connects to the Internet.

The client software comprises (a) an Operating System 142, such as Windows Vista, which manages the system resources, and (b) a Web Browser 144, such as Firefox, Internet Explorer, Chrome, Safari, or Opera, which manages HTTP/Internet interactions. The Web Browser 144 processes HTML Code 146 and JavaScript Code 148 received from the Server 100 through HTTP (TCP/IP, Internet) 160. The HTML Code 146 and the JavaScript Code 148 are generated by the PHP Scripts 122 at the server. The JavaScript Code 148 may store temporary data in JavaScript Arrays 150 in order to minimize time-sensitive interactions with the Server 100. For example, menu selections and evaluation annotations are stored in JavaScript Arrays 150.

At present, we believe that this embodiment operates most efficiently, but other embodiments are also satisfactory.

### Detailed Description

### Alternative Embodiments

Alternative embodiments of the processing device may use web-based, client-server implementation comprising a Server 100, a Client 130, and HTTP (TCP/IP, Internet) 160. However, the Server 100 may have different hardware; for example, it may have a processor other than Pentium, it may have multiple processors, it may have more or less volatile memory, it may have more or less persistent storage (e.g., hard disk, flash, etc.), it may have different storage, it may have more or fewer I/O devices, and it may have different network interface, such as wireless. The Server 100 may have different software; for example, it may have a different operating system, such as Unix or Windows, it may have virtualization software, such as VMware, it may have a different HTTP server, such as IIS or Light TPD, it may have a different SQL server, such as Microsoft SQL or Oracle SQL, it may have a different database system, such as Oracle database, and it may have a different script server, such as ASP or Perl. The Server 100 may be a PC style computer, a notebook computer, a desktop computer, a Mac, a Linux system, a Unix system, a portable device, an appliance with embedded software, an appliance with hardware implementation, or other. The hardware and/or software may include or consist entirely of proprietary components. A combination or hybrid of the first embodiment and/or the various different components described above may also be feasible.

Other alternative embodiments may use web-based, client-server implementation comprising a Server 100, a Client 130, but not HTTP (TCP/IP, Internet) 160. For example, the network interface may or may not be HTTP, the low-level network interface may or may not be TCP/IP, and the network may or may not be Internet based; for instance, a local area network may suffice. The hardware and/or software may include or consist entirely of proprietary components. A combination or hybrid of the first embodiment and/or the various different components described above may also be feasible.

Yet other alternative embodiments may use web-based, client-server implementation comprising a Server 100, a Client 130, and HTTP (TCP/IP, Internet) 160. However, the Client 130 may have different hardware; for example, it may have a different processor other than Pentium, it may have multiple processors, it may have more or less memory, it may have more or less storage, it may have different storage, it may have more or fewer I/O devices, and it may have different network interface, such as wireless. The Client 130 may have different software; for example, it may have a different operating system, such as Windows XP, Windows 7, Windows CE, Mac OS, Unix, or Linux. The Client 130 may be a PC style computer, a notebook computer, a desktop computer, a Mac, a Linux system, a Unix system, an iPad, an iPod, a cell phone, a portable device, a handheld device, an appliance with embedded software, an appliance with hardware implementation, or other. The hardware and/or software may include or consist entirely of proprietary components. A combination or hybrid of the first embodiment and/or the various different components described above may also be feasible.

Still other alternative embodiments may use client-server architecture that is Intranet-based, proprietary, thin-client based, other, or a hybrid combination.

In any of the embodiments, the client software may be stored in its entirety on the Client 130, may be downloaded in its entirety from the Server 100, may be downloaded in its entirety from any other device or computer, or may be partially stored in the Client and partially downloaded from the Server 130 and/or any other device or computer.

More alternative embodiments may not use client-server architecture; for instance, the present method and system may be implemented as a standalone program or application running on any device that may or may not be connected to a network or the Internet.

Although the current implementation is web-browser based, any of the embodiments may be implemented using other architectures.

In another alternative embodiment, a browser plug-in may be used.

Although the current implementation uses PHP for the server software and JavaScript and HTML for the client software, any of the embodiments may use other programming languages and environments, such as any or a combination of HTML, JavaScript, Flash, C, C++, Java, Visual Basic, and/or others.

Although the description refers to using a mouse to interact with and navigate through the user interface, it should be understood that touch-screen, voice commands, WII input device, keyboard, or other instruments may be used in lieu of or in addition to a mouse.

Although the description refers to using a keyboard as an input device, it should be understood that touch-screen, voice, WII input device, or other instruments may be used in lieu of or in addition to a keyboard.

### Detailed Description

### FIG. 3 to FIG. 3B—Annotation Versus Comments

An evaluation is a group of annotations providing feedback about an activity, such as a speech. Annotations are generated from canned comments and/or custom comments using a menu system. An annotation is an instantiation of a comment. An evaluation may include multiple annotations of the same comment.

Turning to FIG. 3, comments are organized in a multi-level hierarchy of: Comment Categories 170, Comment Subcategories 172, and Comment Sub-subcategories 174.

FIG. 3A illustrates a perspective multi-level hierarchy of comments of an activity; Comment Categories 170 define the broadest and highest level of the activity evaluation criteria. Within the Comment Categories 170, each comment category has one or more Comment Subcategories 172. Within the Comment Subcategories 172, each comment subcategory has one or more Comment Sub-subcategories 174.

Furthermore, there are canned comments and custom comments. Canned comments are predefined, built-in, and provided by the software for all users to utilize as a convenient, fast, and consistent way to generate and view evaluations. Custom comments, in comparison to canned comments, are defined by the evaluator for use in evaluations by that evaluator only and may be shared with other evaluators. Canned comments and custom comments are organized in Comment Categories 170, Comment Subcategories 172, and Comment Sub-subcategories 174.

FIG. 3B illustrates a perspective multi-level hierarchy of canned comments with a public speaking activity; Comment Categories 180 define the broadest and highest level of public speaking evaluation criteria, such as Vocalics, Kinesics, Artifacts, Organization, Persuasion, and Evidence. Within the Comment Categories 180, each comment category has one or more Comment Subcategories 182; for instance, the Vocalics category contains subcategories such as Vocalized Pause, Unfilled Pause, Vocal Emphasis, Volume, Pitch, and Rate. Within the Comment Subcategories 182, each comment subcategory has one or more Comment Sub-subcategories 184; for instance, the Vocalized Pause subcategory contains sub-subcategories such as Many Vocalized Pauses, “Ah” Vocalized Pause, “Uh” Vocalized Pause, “Um” Vocalized Pause, “Like” Vocalized Pause, and “Sort of” Vocalized Pause.

Associated with each comment are, at least, a comment ID, a comment title, a comment description, and a comment impact. The comment ID identifies the comment from other comments. The comment title consists of a few words summarizing the comment. The comment description is a detailed explanation of the comment. The comment impact defines whether the comment is positive, neutral, or negative; the comment impact also defines the comment's level of impact, the higher the number, the more severe the impact. For instance, a 0 impact indicates a neutral comment, a −1 impact indicates a negative comment, and a +1 indicates a positive comment. Optionally associated with each canned comment ID are supplemental informational content and community-contributed content. The supplemental informational content is additional information provided to help the user learn more about the comment; it may be in the form of a webpage, pop-up window, or other facility that contains information related to the comment and/or contains a set of hyperlinks to articles, videos, resources, sample speeches, or other items in the website and/or in other websites. The community-contributed content may be in the form of a blog, articles, remarks, videos, and/or other information provided by the community of users about the comment or related to the comment; the community-contributed content may or may not be moderated by a usage panel, panel of experts, or by the website content manager.

### Detailed Description

### FIG. 4 to FIG. 5C—Operation of Displays

FIG. 4 to FIG. 5C illustrate the User-Interface Display Window 190 of the present method and system. The User-Interface Display Window 190 may be displayed on a notebook computer, desktop computer, or other device, such as iPad, iPod, cell phone, or other device. In one embodiment, the User-Interface Display Window 190 is displayed on the monitor of the processing device or the monitor of the client.

Turning to FIG. 4, the User-Interface Display Window 190 has different contents depending on whether in evaluation mode or view mode. Evaluation mode is when an evaluator is conducting an evaluation and generating annotations. View mode is when a viewer is viewing an evaluation without permission to change the evaluation. As shown in FIG. 4A, in evaluation mode, the User-Interface Display Window 190 has four panes (display sections): an Activity Pane 192, a Menu 194, an Annotation Tags Pane 196, and an Annotation Pane 198. As shown in FIG. 4B, in view mode, the User-Interface Display Window 190 has three panes: an Activity Pane 192, an Annotation Tags Pane 196, and an Annotation Pane 198. In view mode, the Menu 194 is not displayed.

Turning to FIG. 5, depending on whether the user is evaluating or viewing an activity in a prerecorded video file, a prerecorded audio file, or a live event, the Activity Pane 192 displays a Video Pane 200, an Audio Pane 202, or a Live Activity Timer Pane 204; in view mode, the Menu 194 is not displayed. As shown in FIG. 5A, when evaluating a prerecorded video file, the Activity Pane 192 displays a Video Pane 200. The Video Pane 200 displays the prerecorded video as well as standard video player controls, such as Play/Pause, and Forward/Backward. As shown in FIG. 5B, when evaluating a prerecorded audio file, the Activity Pane 192 displays an Audio Pane 202. The Audio Pane 202 displays standard audio player controls, such as Play/Pause, and forward/backward. As shown in FIG. 5C, when evaluating a live activity, the Activity Pane 192 displays a Live Activity Timer Pane 204. The Live Activity Timer Pane 204 displays a running time, along with controls, such as start timer and stop timer.

This activity display scheme of the present method and system permits evaluators to evaluate and annotate prerecorded speech videos, prerecorded speech audio files, or live speeches using the same user interface; this activity display scheme of the present method and system also permits viewers to view prerecorded speech videos, prerecorded speech audio files, or live speeches using the same user interface.

In addition, when evaluating or viewing an activity in a prerecorded video file or a prerecorded audio file, the Activity Pane 192 provides enhanced video or audio player controls in the form of buttons (as well as possibly keyboard shortcuts), such as Play/Pause, forward/backward two (2) seconds, forward/backward five (5) seconds, forward/backward ten (10) seconds, forward/backward thirty (30) seconds, forward/backward to the next or to the previous annotation, forward/backward to the end or the beginning of the activity within the video or audio, and forward/backward to the end or the beginning of the video or audio.

The enhanced video and audio playback capabilities of the present method and system improve navigation. For example, the forward/backward capabilities are especially useful when working with long video or audio recordings where the time scale of standard video and audio players is not easily adjusted by the evaluator using the standard video player controls.

Some of the display fields in the User-Interface Display Window 190 are clickable. For example, the Activity Pane 192 has standard video or audio player control buttons that the user can click, enhanced video or audio player control buttons that the user can click; the Menu 194 has menu items that an evaluator can click; the Annotation Tags Pane 196 has annotation tags that a user can click; and the Annotation Pane 198 has fields that the user can click. The act of clicking on a clickable field results in various actions described below.

In addition, the act of mousing over, but not clicking, a clickable field causes the contents displayed in the User-Interface Display Window 190 to change; for instance, additional information or help information may be displayed as a result of mousing over a clickable item. The mouse-over is subject to a hover delay, which is customizable by the user. The value of the hover delay is used to control when the contents displayed in the User-Interface Display Window 190 to change in response to mousing over a clickable field. For example, a hover delay of zero causes the contents displayed in the User-Interface Display Window 190 to change immediately in response to mousing over a clickable field; a hover delay of one second causes the contents displayed in the User-Interface Display Window 190 to change one second after mousing over a clickable field; and a hover delay of two seconds causes the contents displayed in the User-Interface Display Window 190 to change two seconds after mousing over a clickable field.

The type of information displayed as a result of mousing over a clickable field, after the hover delay, depends on the type of clickable field. For example, mousing over an enhanced video or audio player control button in the Activity Pane 192 may display a hover box containing help or hint information about the control button; mousing over a menu item in the Menu 194 may display a hover box containing a description of the menu item; mousing over an annotation tag in the Annotation Tags Pane 196 causes the Annotation Pane 198 to display annotation information corresponding to the annotation tag; and mousing over a clickable button in the Annotation Pane 198 displays a hover box containing help or hint information about the clickable button. Details are described below.

### Detailed Description

### FIG. 6 to FIG. 6F—Operation of Menus

Turning to FIG. 6, the Menu 194 is organized into a hierarchical multi-level menu comprising menus, submenus, and sub-submenus. As shown in FIG. 6A, the Menu 194 contains Menu Selections 210, Submenu Selections 212, and Sub-submenu Selections 214. There is a one-to-one correspondence between Menu Selections 210 and Comment Categories 170, between Submenu Selections 212 and Comment Subcategories 172, and between Sub-submenu Selections 214 and Comment Sub-subcategories 174. For each comment category there is a corresponding menu selection; for each comment subcategory there is a corresponding submenu selection; and for each comment sub-subcategory there is a corresponding sub-submenu selection. The text displayed in the Menu 194 for a menu selection, submenu selection, or sub-submenu selection is the comment title of the corresponding comment category, comment subcategory, or comment sub-subcategory. In other words, the text displayed in any menu item is the comment title of the corresponding comment.

Within the Menu Selections 210, each menu item (menu selection, e.g., Vocalics) has one or more Submenu Selections 212. Within Submenu Selections 212, each menu item (submenu selection, e.g., Vocalized Pause) has one or more Sub-submenu Selections 214 (e.g., Many Vocalized Pauses). Within Sub-submenu Selections 214, each menu item is a sub-submenu selection (e.g., Many Vocalized Pauses).

At any point, depending on the location of the mouse, the Menu 194 may display: (a) the Menu Selections 210 only; (b) the Menu Selections 210 and the Submenu Selections 212 of the currently moused-over menu item within Menu Selections 210; or (c) the Menu Selections 210, the Submenu Selections 212 of the currently moused-over menu item with the Menu Selections 210, and the Sub-submenu Selections 214 of the currently moused-over menu item within the Submenu Selections 212. If the mouse is outside the Menu 194, the Menu 194 displays only the Menu Selections 210. If the mouse is over any of the Menu Selections 210, the Menu 194 displays the Menu Selections 210 and the Submenu Selections 212 of the currently moused-over menu item within Menu Selections 210. If the mouse is over any of the Submenu Selections 212, the Menu 194 displays the Menu Selections 210, the Submenu Selections 212 of the currently moused-over menu item with the Menu Selections 210, and the Sub-submenu Selections 214 of the currently moused-over menu item within the Submenu Selections 212.

The evaluator can create an annotation by choosing a menu item from any menu level by clicking on the menu item; this action creates an annotation containing a comment corresponding to the clicked menu item.

This hierarchical multi-level menu scheme of the present method and system permits evaluators to quickly navigate the menu, menu selections, submenu selections, and sub-submenu selections simply by moving the mouse. The single-action menu scheme of the present method and system permits evaluators to choose a menu item from the Menu Selections 210, the Submenu Selections 212, or the Sub-submenu Selections 214, with a single-action user input, which can be one mouse click, one keyboard shortcut, one touch-screen action, one voice command, or one WII input device action.

Although only three levels are shown in the Menu 194, it should be understood that the number of levels may be more or fewer. For instance, sub-subcategories may be expanded to contain sub-sub-subcategories or contracted to only one level with no subcategories. Furthermore, within the same system, some subcategories may contain sub-subcategories while subcategories may not contain sub-subcategories; likewise, some sub-subcategories may contain sub-sub-subcategories while other sub-subcategories may not contain sub-sub-subcategories.

As shown in FIG. 6B, the Menu 194 may also contain a Menu Item Description 216, in addition to the Menu Selections 210, Submenu Selections 212, and Sub-submenu Selections 214. The Menu Item Description 216 is a hover box containing a description of the currently moused-over menu item from the Menu Selections 210, the Submenu Selections 212, or the Sub-submenu Selections 214. The Menu Item Description 216 hover box is a window, a pop-up window, or some other facility that may be displayed after a hover delay starting from mousing over the menu item and continuing as long as the mouse remains on a menu item. The hover delay is customizable by the user. The Menu Item Description 216 is the description of the comment that corresponds to the menu item.

This Menu Item Description scheme of the present method and system gives evaluators convenient and immediate help about the menu.

As shown in FIG. 6C, the Menu Selections 210 contain the comment categories, such as Vocalics, Kinesics, Organization, and Evidence. The Submenu Selections 212 contain the comment subcategories within the comment categories; for instance, the Submenu Selections 212 for Vocalics include Vocalized Pause, Vocal Emphasis, Volume, Pitch, and Rate. The Sub-submenu Selections 214 contain comment sub-subcategories within the comment subcategories; for instance, the Sub-submenu Selections 214 for Vocalized Pause include Many Vocalized Pauses, “Ah” Vocalized Pause, and “Uh” Vocalized Pause.

Another aspect of the Menu 194 is how the menu expands and contracts as the evaluator browses over the menu. When the evaluator mouses over a menu item (menu selection) from the Menu Selections 210, the menu expands, displaying the Submenu Selections 212 of the currently moused-over menu item. Likewise, when the evaluator mouses over a menu item (submenu selection) from the Submenu Selections 212, the menu expands further, displaying the Sub-submenu Selections 214 of the currently moused-over menu item. As the evaluator mouses in and out of menu selections, submenu selections, and sub-submenu selections, the menu expands and contracts. This allows the evaluator to drill down into and drill up out of the hierarchical multi-level menu levels. For instance, if the evaluator mouses over the Vocalics menu selection, the menu expands, displaying the Vocalics submenu; if the evaluator then mouses over the Vocalized Pause submenu selection, the menu expands further, displaying the Vocalized Pause sub-submenu; if the evaluator mouses over the Vocalics menu selection again, the menu contracts, displaying only the Vocalics submenu, but not the Vocalized Pause sub-submenu.

As shown in FIG. 6D, another aspect of the Menu 194 is menu overlay as the menu expands and contracts. When the evaluator mouses over a menu item (menu selection) from the Menu Selections 210, the menu expands, displaying the Submenu Selections 212 of the currently moused-over menu item; to conserve screen space and make room for the menu expansion, the Menu Selections 210 are partially overlaid with the Submenu Selections 212. For instance, if the evaluator mouses over the Vocalics menu selection, the menu expands, displaying the Vocalics submenu; the Menu Selections 210 are only partially displayed as they are overlaid by the Submenu Selections 212 of the Vocalics submenu. Partial overlaying provides visibility of the top level menus, and gives the evaluator context of the menu level being displayed.

As shown in FIG. 6B, a Menu Item Description 216 may also be displayed; the Menu Item Description 216 provides details about the currently moused-over menu item; for instance, the Menu Item Description 216 for Vocalized Pause may be the text shown in FIG. 6E.

As shown in FIG. 6F, the Menu 194 comprises Canned Comment Selections 220 and/or Custom Comment Selections 222. Both the Canned Comment Selections 220 and the Custom Comment Selections 222 consist of Menu Selections 210, Submenu Selections 212, and Sub-submenu Selections 214. The Canned Comment Selections 220 are predefined by the software of the present method or system. Any of the Custom Comment Selections 222 may be defined by the evaluator by entering text chosen by the evaluator or may be defined by the evaluator to map into one of the Canned Comment Selections 220.

This canned and custom menu scheme of the present method and system gives an evaluator the ability to use predefined menu items and to define and use custom menu items.

The Menu 194 may be color coded using a color-coding scheme, whereby each menu item in the Menu Selections 210 has a unique color that is different from the other menu items in the Menu Selections 210. The Submenu Selections 212 of each menu item use the same or a variation of the color of that menu item. For instance, if the Vocalics menu item is blue, the Submenu Selections 212 of the Vocalics menu item are also blue or a variation of blue. Similarly, the Sub-submenu Selections 214 of each menu item use the same or a variation of the color of that menu item within the Submenu Selections 212. For instance, if the Vocalized Pause menu item is blue, the Sub-submenu Selections 214 of the Vocalized Pause menu item are also blue or a variation of blue. In addition, the Menu Item Description 216 also uses the same or a variation of the color of the currently moused-over menu item.

This menu color-coding scheme of the present method and system makes menu navigation more intuitive by displaying items within a group with the same or similar color.

### Detailed Description

### FIG. 7 to FIG. 8A—Operation of Annotations

When an evaluator clicks on a menu item, an annotation is automatically generated. An annotation is one instantiation of a comment associated with a specific timestamp. Clicking on the same menu item again will generate another annotation with the same comment. Associated with an annotation are, at least, a timestamp of the annotation, the comment ID of the selected menu item, the comment title, the comment description, the comment impact, a custom note, and an annotation duration. The custom note is initially blank but may be filled by the evaluator at annotation time or at a later time. Each annotation may have its own custom note. Optionally associated with each canned comment ID are supplemental informational content and community-contributed content.

Turning to FIG. 7, the Annotation Tags Pane 196 contains zero, one, or more annotation tags. An annotation tag is a subset of the annotation information within an evaluation. The annotation tag gives a brief snapshot of the annotation. Multiple annotation tags may be displayed in the Annotation Tags Pane 196, giving a summary view of the evaluation. Annotation tags scroll up with time and as more annotation tags are added. The user can scroll up and down through the annotation tags in the Annotation Tags Pane 196. An annotation tag is generated automatically whenever the evaluator chooses a menu item from the Menu Selections 210, the Submenu Selections 212, or the Sub-submenu Selections 214 in the Menu 194 with a mouse click (or other ways). An annotation tag is an entry in the Annotation Tags Pane 196. The user of the evaluation can jump to any annotation tag by clicking on the desired annotation tag; the user can move forward and backward between annotation tags by clicking on any annotation tag or by using the enhanced video or audio player controls. As a result, some previously generated annotation tags may appear before the current time, some previously generated annotation tags may appear after the current time, and a previously generated annotation tag may coincide with the current time.

As shown in FIG. 7A, the Annotation Tags Pane 196 contains Previous Annotation Tags 230, a Current Annotation Tag 232, and Next Annotation Tags 234. The type of information displayed in the annotation tag is the same in the Previous Annotation Tags 230, in the Current Annotation Tag 232, and in the Next Annotation Tags 234. As shown in FIG. 7B, the annotation tag may contain a Tag Timestamp 240, a Tag Comment Impact 242, and a Tag Comment Title 244. The Tag Timestamp 240 is the elapsed time at which the annotation tag was generated from the start of the activity. The Tag Comment Impact 242 is a symbol signifying whether the comment is negative, neutral, or positive. The Tag Comment Title 244 is the title of the comment of that annotation tag.

This annotation tagging scheme of the present method and system gives users a time-based summary overview of previous, current, and next annotations.

The Annotation Tags Pane 196 uses a color-coding scheme with three different colors, whereby the Previous Annotation Tags 230 have one color, the Current Annotation Tag 232 has another color, and the Next Annotation Tags 234 have yet another color.

This annotation tag color scheme of the present method and system makes tags visually intuitive.

Turning to FIG. 8, the Annotation Pane 198 displays all the annotation information for the currently moused-over annotation tag or the last clicked annotation tag whichever is last. The currently moused-over annotation tag or the last clicked annotation tag may be in the Previous Annotation Tags 230, in the Current Annotation Tag 232, or in the Next Annotation Tags 234. Clicking on an annotation tag in the Annotation Tags Pane 196 causes the video or audio to jump to the location of the annotation tag; it also causes the Annotation Pane 198 to display the annotation information corresponding to the clicked annotation tag. Mousing over, but not clicking, on an annotation tag in the Annotation Tags Pane 196 causes the Annotation Pane 198 to display the annotation information corresponding to the moused-over annotation tag. In other words, once an annotation tag is clicked or moused over, the Annotation Pane 198 is automatically updated to display information related to the chosen annotation tag.

As shown in FIG. 8A, the Annotation Pane 198 contains an Annotation Timestamp 250, an Annotation Comment Impact 252, an Annotation Comment Title 254, an Annotation Comment ID 256, an Annotation Comment Description 258, an Annotation Custom Note 260, an Annotation Duration 262, Supplemental Informational Content 264, and Annotation Community-Contributed Content 266.

The Annotation Timestamp 250, Annotation Comment Impact 252, and Annotation Comment Title 254 are the same as the Tag Timestamp 240, Tag Comment Impact 242, and Tag Comment Title 244, respectively, of the currently moused-over annotation tag or the last clicked annotation tag, whichever is last. The Annotation Comment Description 258 is the same as the Menu Item Description 216 of the currently moused-over annotation tag or the last clicked annotation tag. The Annotation Custom Note 260 is blank when the annotation is generated initially, but the evaluator may fill it with any text and save that text. The saved text will only be for the currently moused-over annotation tag (if the evaluator moused over a tag) or the last clicked annotation tag (if the evaluator clicked an annotation), but not for other annotation tags. The evaluator can later add or modify the text of the Annotation Custom Note 260. The Annotation Duration 262 can be set and modified by the evaluator at annotation time or at a later time; there is also a default value for the Annotation Duration 262, so that if the evaluator does not set the value, the default is used. The Supplemental Informational Content 264 and Annotation Community-Contributed Content 266 are the same as the supplemental informational content the community-contributed content of the comment corresponding to the currently moused-over annotation tag or the last clicked annotation tag.

This annotation scheme of the present method and system gives users the ability to see all information related to the previous, current, or next annotation tags by mousing over any annotation tag, without jumping to that annotation tag. This annotation scheme of the present method and system gives the user the ability to add canned and/or custom details to any annotation. This annotation scheme of the present method and system also gives evaluators the ability to add annotation-specific notes.

The Annotation Pane 198 uses a color-coding scheme, whereby the color of the Annotation Timestamp 250, the Annotation Comment Impact 252, the Annotation Comment Title 254, the Annotation Comment ID 256, the Annotation Comment Description 258, the Annotation Custom Note 260, and the Annotation Duration 262, match the color of the currently moused-over annotation tag or the last clicked annotation tag, which may be the color of the Previous Annotation Tags 230, the color of the Current Annotation Tag 232, or the color of the Next Annotation Tags 234.

This annotation pane color scheme of the present method and system makes annotations and annotation tags more intuitive by matching the annotation pane color with the color of the currently moused-over annotation tag or the last clicked annotation tag.

The locations of the panes within the User-Interface Display Window 190 and the locations of the fields within each pane may vary. The location as well as presence of annotation elements in the Annotation Tags Pane 196 and the Annotation Pane 198 may vary. The specific locations and elements shown in the figures are for demonstrative purposes.

### Detailed Description

### Operation of Other Aspects

Another aspect of the present method and system is synchronization of evaluation annotations of a live activity (e.g., speech) with a recording of the activity. A user can associate a video or an audio file with an evaluation of a live activity by specifying the location of the file. For example, an evaluator may generate an evaluation of a live activity and later receives a recording of that activity; the evaluator can associate the recording with the evaluation, which automatically synchronizes the recording with the evaluation timestamps.

Another aspect of the present method and system is adjusting the annotation timestamps. There are three ways for an evaluator to adjust annotation timestamps. The first way is by using a global offset value that adjusts all timestamps of all already generated annotations of an existing evaluation. The second way is by using a global offset value that adjusts the timestamp of every annotation at annotation generation time. The third way is by adjusting the timestamp value of the currently moused-over annotation tag or the last clicked annotation tag.

Another aspect of the present method and system is the ability to delete annotations and evaluations. An evaluator can delete annotations and entire evaluations.

Another aspect of the present method and system is the ability to generate marks. Marks are blank annotations used to remind evaluators of locations in the evaluation to revisit later.

Another aspect of the present method and system is generating evaluation reports. A user can generate an evaluation report from the plurality of annotations in an evaluation. The user can select all or specific comment types to include in the evaluation report; the user can also select what comment fields to include in the evaluation report. The user can also select whether the evaluation report is organized by comment category or in chronological order of annotations.

Another aspect of the present method and system is menu customization. The evaluator can define and redefine the custom Menu Selections 210, Submenu Selections 212, and Sub-submenu Selections 214 by adding the evaluator's own comment titles and comment descriptions or by mapping the custom menu selections into canned Menu Selections 210, Submenu Selections 212, or Sub-submenu Selections 214. Mapping a custom menu selection into a canned menu selection is accomplished with a single-action user input by simply clicking on the menu item while in menu customization mode.

Another aspect of the present method and system is statistical and trend analysis of evaluations, annotations, comments, evaluators, and evaluatees. An evaluator may compare the frequency and use of comment types in a specific evaluation with the average frequency and use of all comment types in all the evaluator's own evaluations. An evaluator may compare the frequency and use of comment types in a specific evaluation with the average frequency and use of all comment types in all other evaluators' evaluations. An evaluator may also compare the evaluator's average frequency and use of all comment types with the average frequency and use of all comment types in all other evaluators' evaluations. An evaluatee may compare the frequency and use of comment types in a specific evaluation of an evaluatee with the average frequency and use of all comment types in all the evaluatee's own evaluations. An evaluatee may compare the frequency and use of comment types in a specific evaluation of the evaluatee with the average frequency and use of all comment types in all other evaluatees' evaluations. An evaluatee may also compare the evaluatee's average frequency and use of all comment types with the average frequency and use of all comment types in all other evaluatees' evaluations and in all other evaluators' evaluations.

Another aspect of the present method and system is searching. A user can search for comment types in the current evaluation, in evaluations of a specific evaluator, or in evaluations of all evaluators.

Another aspect of the present method and system is the ability to mark the start and the end of the activity within a video recording or an audio recording. The evaluator can then select to start video playback automatically beginning from the start of the activity within the recording. For example, with speech evaluation, this capability is especially useful to skip introductory remarks by someone other than the speaker to evaluate.

Another aspect of the present method and system is the ability to skip all video and audio in a recording except the annotations. The user can enable or disable this feature at any time while evaluating or viewing an evaluation. When enabled, the annotations will be played, but the video or audio in between annotations is skipped. For instance, if an evaluation video has two annotations: a first annotation starting at timestamp 02:15 and lasting 7 seconds, and a second annotation starting at timestamp 05:46 and lasting 10 seconds; if skip mode is enabled, the video will start at time 02:15 for 7 seconds, then jump to time 05:46 for 10 seconds; the rest of the video is skipped.

Another aspect of the present method and system is the comment ID coding. In one embodiment, comment IDs are five characters long; the first character is a letter corresponding to a menu selection; the second and third characters are two digits corresponding to a submenu selection; the fourth and fifth characters are two digits corresponding to a sub-submenu selection. For example, V0204 is the comment ID for the fourth sub-submenu selection within the second submenu selection within the Vocalics menu selection; as shown in FIG. 3B, V0204 is ‘“Um” Vocalized Pause.’

### Detailed Description

### Operation of Keyboard Shortcuts

Another aspect of the present method and system is keyboard shortcuts. The purpose of the keyboard shortcuts is to provide the user an alternative to the mouse/click interface. Some users may find keyboard shortcuts more convenient, expeditious, and ergonomic than the mouse/click interface. There are two types of keyboard shortcuts: hotkeys and predefined shortcut sequences. Hotkeys are single-key keyboard shortcuts; each hotkey keystroke causes an immediate action. There are two types of hotkeys: predefined hotkeys and user-defined hotkeys. Currently, the user-defined hotkeys are the numeric digits 0-9. The predefined hotkeys include some punctuation keys, such as the comma key, and some letters, such as the X key. Predefined shortcut sequences consist of multi-key keyboard shortcuts that correspond to menu selections. Predefined shortcut sequences provide the evaluator with an alternative to the comment menus to create annotations. In summary, there are two types of keyboard shortcuts:

1. Hotkeys:
A. Predefined hotkeys
B. User-defined hotkeys

2. Predefined shortcut sequences

The next sections describe the three types of keyboard shortcuts.

### Detailed Description

### Predefined Hotkeys

There are several predefined hotkeys. Each predefined hotkey consists of a single character keystroke, which can be a punctuation key, such as the comma key, or a letter, such as the X key. Each predefined hotkey causes a predefined action. The actions performed by predefined hotkeys are not menu selections; in other words, predefined hotkey actions are not shortcuts for menu selections.

One of the predefined hotkeys is the ‘X’ letter, which inserts a mark. Another predefined hotkey is the ‘=’ character, which repeats the previous annotation (adds an annotation containing the comment that was added last). Another predefined hotkey is the ‘.’ character, which pauses or resumes the video playback. Another predefined hotkey is the ‘[’ character, which moves the video playback to the previous annotation tag. Another predefined hotkey is the ‘]’ character, which moves the video playback to the next annotation tag. Another predefined hotkey is the ‘,’ character, which allows the evaluator to add or edit a custom note and adjust the annotation duration. Another predefined hotkey is the ‘;’ character, which indicates the end of an annotation, from which the annotation duration is automatically calculated.

Below is a summary of the predefined hotkeys:

X Insert mark

= Insert same comment as the last previously inserted one

. Pause/Play video playback

[ Go backward to previous tag

] Go forward to next tag

, Add or edit custom note and adjust timestamp

; End annotation duration of current tag

### Detailed Description

### User-Defined Hotkeys

There are also several user-defined hotkeys. Each user-defined hotkey consists of a single character keystroke. Currently, the user-defined hotkeys are the numeric digits 1 through 9 and 0, but letters or other characters may also be used as user-defined hotkeys in alternative implementations. Each user-defined hotkey causes an action defined by the user. The actions performed by user-defined hotkeys are menu selections as defined by the user; in other words, user-defined hotkey actions are shortcuts for menu selections. The user-defined hotkeys can be mapped into any of the canned or custom Menu Selections 210, Submenu Selections 212, and Sub-submenu Selections 214. Mapping a user-defined hotkey into a menu selection is done by clicking on the menu item while in keyboard shortcut customization mode.

### Detailed Description

### FIG. 9A to FIG. 9C—Predefined Shortcut Sequences

There are also several predefined shortcut sequences. Currently, there are two types of predefined shortcut sequences: double-key predefined shortcut sequences, and triple-key predefined shortcut sequences. Each predefined shortcut sequences causes a predefined action. The actions performed by the predefined shortcut sequences are menu selections; in other words, predefined shortcut sequences actions are shortcuts for menu selections. The predefined shortcut sequences are pre-mapped into canned and custom Menu Selections 210, Submenu Selections 212, and Sub-submenu Selections 214.

As shown in the example of FIG. 9A, the double-key predefined shortcut sequences consist of two consecutive keys each: one letter (pressed and released) followed by one digit (pressed and released). The letter corresponds to the first letter of a menu selection within the Menu Selections 210; the digit corresponds to a submenu selection within the Submenu Selections 212. For example: the double-key predefined shortcut sequence V2 maps into the second submenu selection in the Vocalics menu selection; in other words, when the evaluator presses and releases V then presses and releases 2, it is as if the evaluator clicked the second submenu selection in the Vocalics menu selection using the mouse. Another example is the double-key predefined shortcut sequence P3, which maps into the third submenu selection in the Persuasion menu selection; in other words, when the evaluator presses and releases P then presses and releases 3, it is as if the evaluator clicked the third submenu selection in the Persuasion menu selection using the mouse. Additionally, the double-key predefined shortcut sequences starting with the letter C map into the corresponding submenu selections within the custom menu selection; therefore, an evaluator can define custom submenu selections and can use the double-key predefined shortcut sequences starting with the letter C to select any of the custom submenu selections.

As shown in the examples of FIG. 9B and FIG. 9C, the triple-key predefined shortcut sequences consist of three consecutive keys each: one letter followed by two digits; the letter is pressed and kept pressed, the first digit is pressed and released, the letter is released, then the second digit is pressed and released. The letter corresponds to the first letter of a menu selection within the Menu Selections 210; the first digit corresponds to a submenu selection within the Submenu Selections 212; the second digit corresponds to a sub-submenu selection within the Sub-submenu Selections 214. For example: the triple-key predefined shortcut sequence V23 maps into the third sub-submenu selection within the second submenu selection in the Vocalics menu selection; in other words, when the evaluator presses and keeps pressed the letter V, then presses and releases 2, then releases the letter V, then presses and releases 3, it is as if the evaluator clicked the third sub-submenu selection within the second submenu selection in the Vocalics menu selection using the mouse. Additionally, the triple-key predefined shortcut sequences starting with the letter C map into the corresponding submenu selections within the custom menu selection; therefore, an evaluator can define custom submenu selections and can use the triple-key predefined shortcut sequences starting with the letter C to select any of them.

It should be understood that the scheme used in the predefined shortcut sequences may be expanded into multi-level keyboard shortcuts spanning more than two digits.

Another unique aspect of the triple-key predefined shortcut sequences is the ability to switch between submenus in the middle of a triple-key predefined shortcut sequence. When an evaluator presses and keeps pressed a menu selection letter (e.g., V for Vocalics or K for Kinesics), the corresponding submenu selection is displayed, allowing the evaluator to press any digit that corresponds to a submenu selection. As long as the letter is still held (not released yet), the evaluator can enter any of the digits that correspond to submenu selections and see the corresponding sub-submenu selections. This feature allows the evaluator to see the different sub-submenus without committing to any of them until the letter is released. For example, if the evaluator presses and keeps pressed the letter V, the Vocalics submenu opens; if the evaluator then presses and releases the digit 3, the third Vocalics sub-submenu opens; if then the evaluator presses and releases the digit 2, the second Vocalics sub-submenu opens; the evaluator may continue browsing sub-submenus as long as the letter V is still pressed. As soon as the letter is released, the evaluator is considered to have committed to and selected the submenu of that last digit; any digit entered afterwards by the evaluator will select the sub-submenu selection corresponding to that last digit.

As shown in the example of FIG. 9A, another unique aspect of the double-key and triple-key predefined shortcut sequences is the menu display. The menu display shows, for each menu selection, the corresponding letter; for example, the menu selection display that has Vocalics also has the letter V, whereas the menu selection display that has Kinesics has the letter K; these letters serve as keyboard shortcut reminders for the evaluator. When the evaluator presses any of these letters, the corresponding submenu is displayed; in addition, each submenu selection display includes the corresponding digit; these digits serve as keyboard shortcut reminders for the evaluator; for example, if the evaluator presses the letter K, the Kinesics submenu is displayed, and each Kinesics submenu selection will include a display of the corresponding digit.

As shown in the examples of FIG. 9B and FIG. 9C, with triple-key predefined shortcut sequences, when the evaluator presses (and keeps pressed) a predefined letter, then presses and releases a digit, the corresponding sub-submenu is displayed; at this point the sub-submenu display does not include the corresponding sub-submenu digits; in other words, at this point, the submenu digits are displayed, but the sub-submenu digits are not shown; this indicates to the evaluator that typing a number will select a submenu selection, rather than a sub-submenu selection; once the evaluator releases the letter, the submenu digits disappear and the sub-submenu digits are shown; this scheme walks the evaluator through the predefined shortcut sequences; for example, if the evaluator presses (and keeps pressed) K, the Kinesics submenu is displayed, and each Kinesics submenu selection includes a display of the corresponding digit; if the evaluator then presses and releases the digit 2, the sub-submenu of the second Kinesics submenu is displayed but without digits; if the evaluator presses and releases the digit 4, the sub-submenu of the fourth Kinesics submenu is displayed but without digits; once the evaluator releases the K letter, the submenu digits disappear and the digits of the sub-submenu of the fourth Kinesics submenu are displayed.

Another unique aspect of the double-key and triple-key predefined shortcut sequences is the interaction with mouse movements. A mouse movement in the middle of a keyboard shortcut sequence terminates that keyboard shortcut sequence and resumes using the regular menu interface described earlier. For instance, if the evaluator presses and releases the letter V to start a double-key Vocalics shortcut sequence, the Vocalics submenu is displayed showing the reminder submenu digits; if at that point the evaluator mouses over a menu item or a submenu item, the digits will disappear, signaling that the shortcut sequence is no longer in progress; the menu, submenu, and sub-submenu displays now track the mouse. Another example is if the evaluator presses and keeps pressed the letter V to start a triple-key Vocalics shortcut sequence, the Vocalics submenu is displayed showing the reminder digits; if the evaluator then presses a digit and releases the letter V and the digit, the sub-submenu corresponding to the digit is displayed with reminder sub-submenu digits; if the evaluator mouses over a menu item, a submenu item, or a sub-submenu item, the digits will disappear, signaling that the shortcut sequence is no longer in progress; the menu, submenu, and sub-submenu displays now track the mouse.

### Detailed Description

### FIG. 10 to FIG. 10F—Implementation

This section explains a perspective implementation showing the databases used, as illustrated by FIG. 10 to FIG. 10F.

Turning to FIG. 10, the present method and system utilize an Evaluation Database 280, an Annotation Database 282, and a Comment Definition Database 284. The Evaluation Database 280 is used to store information about evaluations, with one database entry per evaluation. Each entry stores information related to the evaluation, such as the location of the video or audio file of a prerecorded activity being evaluated, the duration of the activity, the date and time of the evaluation, the evaluator's name or other identification, viewing permissions, and modification permissions. The location of the video or audio file may be a web address (URL or Unified Resource Location), an address of a file on a local hard disk on the user's computer, an address in a network, or other address. The Evaluation Database 280 is updated and a new database entry is added whenever an evaluator adds an evaluation.

Turning to FIG. 10A, the Annotation Database 282 is used to store information about annotations, with one database entry per annotation. As shown in FIG. 10B, an entry in the Annotation Database 282 contains: (a) an Evaluation ID Annotation Database Entry 290, which identifies the evaluation to which the annotation of the database entry pertains, (b) a Timestamp Annotation Database Entry 292, which stores the timestamp of the annotation of the database entry, (c) a Comment ID Annotation Database Entry 294, which stores the Comment ID of the annotation of the database entry, (d) a Custom Note Annotation Database Entry 296, which stores the custom note of the annotation of the database entry, and (e) an Annotation Duration Annotation Database Entry 298, which stores the annotation duration of the annotation of the database entry.

Turning to FIG. 10C, the Comment Definition Database 284 is used to store information about comments, with one database entry per comment. There are canned comments and custom comments. As shown in FIG. 10D, an entry in the Comment Definition Database 284 contains: (a) a Comment ID Comment Definition Database Entry 300, which stores the ID of the comment of the database entry, (b) a Comment Impact Comment Definition Database Entry 302, which stores the impact of the comment of the database entry, (c) a Comment Title Comment Definition Database Entry 304, which stores the title of the comment of the database entry, (d) a Comment Description Comment Definition Database Entry 306, which stores the description of the comment of the database entry, (e) a Comment Menu Color Comment Definition Database Entry 308, which stores the menu color of the comment of the database entry, (f) a Supplemental Informational Content Comment Definition Database Entry 310, which stores pointers to the supplemental informational content of the comment of the database entry, and (f) a Community-Contributed Content Comment Definition Database Entry 312, which stores pointers to the community-contributed content for the comment of the database entry. Comments are available to the evaluator to choose from using the Menu 194. Only the comment title is displayed in the Menu 194.

The Comment Definition Database 284 is initialized with all the canned comments. The Comment Definition Database 284 is updated whenever custom comments are added, modified, or deleted.

As shown in the perspective flowchart in FIG. 10E, building the Menu 194 display, entails multiple steps. Step 1, the content of the Menu Selections 210, Submenu Selections 212, and Sub-submenu Selections 214 are obtained from plurality of the Comment Title Comment Definition Database Entry 304 fields in the Comment Definition Database 284. In Step 2, the colors of the Menu Selections 210, Submenu Selections 212, Sub-submenu Selections 214, and Menu Item Description 216 are obtained from the Comment Menu Color Comment Definition Database Entry 308 values in the Comment Definition Database 284. In Step 3, the content of the Menu Item Description 216 is obtained from the Comment Description Comment Definition Database Entry 306 field in the Comment Definition Database 284.

As shown in the perspective flowchart in FIG. 10F, building annotations entails multiple steps. In Step 1, an evaluator generates an annotation by choosing a comment from the Menu 194 using the Menu Selections 210, Submenu Selections 212, or Sub-submenu Selections 214. In Step 2, a new database entry is added to the Annotation Database 282 for the newly generated annotation. In Step 3, the fields of the newly generated entry in the Annotation Database 282 are populated as follows: (a) the Evaluation ID Annotation Database Entry 290 is set to the ID of the current evaluation; (b) the Timestamp Annotation Database Entry 292 is set to the current elapsed time; (c) the Comment ID Annotation Database Entry 294 is set to the comment ID of the chosen menu item in Menu Selections 210, Submenu Selections 212, or Sub-submenu Selections 214; (d) the Custom Note Annotation Database Entry 296 is set to a blank value, but it may be updated later if the evaluator adds a note for the annotation; and (e) the Annotation Duration Annotation Database Entry 298 is set to the default annotation duration value, but it may be updated later by the evaluator.

Continuing with FIG. 10F, in Step 4, the Annotation Tags Pane 196 display is then updated to show a new annotation tag for the newly-generated entry in the Annotation Database 282. The display value of the Tag Timestamp 240 is obtained from the Timestamp Annotation Database Entry 292 from the Annotation Database 282. The display values of the Tag Comment Impact 242 and the Tag Comment Title 244 are obtained from the Comment Impact Comment Definition Database Entry 302 and the Comment Title Comment Definition Database Entry 304, respectively, from the entry in Comment Definition Database 284 that contains a Comment ID Annotation Database Entry 294 value that equals the tag comment ID value of the newly-generated annotation.

Continuing with FIG. 10F, next, in Step 5, the Annotation Pane 198 display is updated to show the comment information pertaining to the current annotation tag. The display values of the Annotation Timestamp 250, the Annotation Comment ID 256, Annotation Custom Note 260, and the Annotation Duration 262 are obtained from the Timestamp Annotation Database Entry 292, the Comment ID Annotation Database Entry 294, the Custom Note Annotation Database Entry 296, and the Annotation Duration Annotation Database Entry 298, respectively, from the Annotation Database 282. The display values of the Annotation Comment Impact 252, the Annotation Comment Title 254, the Annotation Comment Description 258, the Supplemental Informational Content 264, and the Annotation Community-Contributed Content 266 are obtained from the Comment Impact Comment Definition Database Entry 302, the Comment Title Comment Definition Database Entry 304, the Comment Description Comment Definition Database Entry 306, Supplemental Informational Content Comment Definition Database Entry 310, and the Community-Contributed Content Comment Definition Database Entry 312, respectively, from the entry in Comment Definition Database 284 that contains a Comment ID Annotation Database Entry 294 value that equals the Annotation Comment ID 256 value.

The order in which the Annotation Tags Pane 196, Annotation Pane 198, and their fields are updated may vary.

### CONCLUSION, RAMIFICATION, SCOPE

As described above, for the evaluator, the present method and system provide evaluations and annotations that are (a) faster and easier to generate, (b) less disruptive to the evaluation process, (c) more easily modified, (d) more versatile, (e) more expansive, (f) less prone to errors, (g) more easily customizable, (h) more flexible, (i) more efficient, (j) easier to learn and use, and (k) easier to navigate.

Furthermore, for the evaluatee, the present method and system provide evaluations and annotations that are (a) more descriptive, (b) more informative, (c) more detailed, (d) more easily correlated to the activity, (e) more helpful, and (f) more consistent across evaluators.

While the above description contains many specificities, these should not be construed as limitations on the scope of the present method and system, but rather as exemplification of one or more embodiments thereof. Many other variations are possible. Also, it should be understood that the implementations shown are merely examples, and should not be considered as limiting in any way the scope of the present method and system.

We claim:

1. A method for evaluating a live activity or a prerecorded activity, including at least one evaluator, comprising: providing a processing device capable of interacting with the evaluator, providing a menu of comments, and generating one or more annotations using said menu.

2. A method as in claim 1 wherein said menu is a hierarchical multi-level menu.

3. A method as in claim 1 wherein said menu and said annotations are color coded.

4. A method as in claim 1 wherein said menu is controlled entirely or in part using keyboard shortcuts or keyboard shortcut sequences corresponding to menu selections.

5. A method as in claim 1 whereby said annotation comprises one or more of a timestamp, a comment ID, a comment title, a comment impact, a comment description, custom note, supplemental informational content, or community-contributed content.

6. A method as in claim 1 further comprising a step of synchronizing said annotations with a recording of said live activity.

7. A method as in claim 1 further comprising a step of customizing said menu.

8. A method as in claim 1 further comprising a step of generating an evaluation report.

9. A method as in claim 1 further comprising enhanced video or audio player controls.

10. A method as in claim 1 wherein said activity is public speaking.

11. A system for evaluating a live activity or a prerecorded activity, including at least one evaluator, comprising: a processing device capable of interacting with the evaluator, a means for providing a menu of comments, and a means for generating one or more annotations using said menu.

12. A system as in claim 11 wherein said menu is a hierarchical multi-level menu.

13. A system as in claim 11 wherein said menu and said annotations are color coded.

14. A system as in claim 11 wherein said menu is controlled entirely or in part using keyboard shortcuts or keyboard shortcut sequences corresponding to menu selections.

15. A system as in claim 11 whereby said annotation comprises one or more of a timestamp, a comment ID, a comment title, a comment impact, a comment description, custom note, supplemental informational content, or community-contributed content.

16. A system as in claim 11 further comprising a means for synchronizing said annotations with a recording of said live activity.

17. A system as in claim 11 further comprising a means for customizing said menu.

18. A system as in claim 11 further comprising a means for generating an evaluation report.

19. A system as in claim 11 further comprising a means for enhanced video or audio player controls.

20. A system as in claim 11 wherein said activity is public speaking.
